(19) United States
(12) Patent Application Publication
(10) Pub. No.: US 2013/0328458 A1
(43) Pub. Date: Dec. 12, 2013

(54) ROTARY SWITCHES

(71) Applicant: Allan David Crane, Gwynedd (GB)

(72) Inventor: Allan David Crane, Gwynedd (GB)

(73) Assignee: GE Energy Power Coversion Technology Ltd., Warwickshire (GB)

(21) Appl. No.: 13/583,123

(22) PCT Filed: Mar. 1, 2011
(86) PCT No.: PCT/EP2011/000979

§ 371 Date: Jul. 25, 2013

(30) Foreign Application Priority Data
Mar. 10, 2010 (EP) 1002507.1

(51) Int. Cl. H02K 57/00

(52) U.S. Cl. CPC H02K 57/006
USPC 310/68 R

(57) ABSTRACT

An improved rotary switch (e.g. a double pole double break switch) includes first and second poles (2, 4). Each pole including a rotatable bridging member (24) and a pair of fixed busbars (6a, 6b; 8a, 8b). Each busbar has at least one primary contact (14) and may also include a contact arm (12) with an arcing contact (28). The rotary switch is adapted such that the direction of current flow through the first pole (2) is opposite to the direction of current flow through the second pole (4). In this way, arcs established in the first pole (2) are deflected away from arcs established in the second pole (4).

### TECHNICAL FIELD

The present invention relates to rotary switches, and in particular to double pole (or multi pole) double break rotary switches for current interruption.

### BACKGROUND ART

Double break rotary switches having any convenient number of poles are well known as disconnect switches or off-load switches and typically include a bridging member that is rotatable to make direct physical contact with fixed contacts or busbars at its opposite ends.

### SUMMARY OF THE INVENTION

The present invention provides an improved rotary switch comprising first and second poles, each pole including a rotatable bridging member and a pair of fixed busbars having at least one primary contact, wherein the rotary switch is adapted such that the direction of current flow through the first pole is opposite to the direction of current flow through the second pole such that arcs established in the first pole are deflected away from arcs established in the second pole.

The rotary switch is particularly useful when applied to dc distribution systems (e.g. as an off-load switch) that are designed to have a low L/R time constant and where high power density is a dominant objective. However, the high arc voltage that is achieved by the rotary switch will also be effective in interrupting dc and ac circuits with significant L/R time constants.

A rotary actuator of any suitable construction is preferably used to rotate the rotatable bridging members between a closed position and an open position. In the closed position the opposite ends of each rotatable bridging member are in direct physical contact with the associated fixed busbars so that current can flow between the busbars through the rotatable bridging member. In the open position the opposite ends of the rotatable bridging member are spaced apart from the associated busbars. The rotary actuator will preferably be able to rotate the rotatable bridging members in both directions (i.e. in a first direction to move from the closed position towards the open position to open the rotary switch and in a second, opposite, direction to move from an open position towards the closed position to close the rotary switch). The rotary actuator may rotate the rotatable bridging members under the control of any regulator or control means such as an electronic control unit, for example. As in other conventional rotary switches, a spring-decent or other snap action rotary drive coupling mechanism can be inserted between the rotary actuator and the rotatable bridging members in order to maximise the speed of rotation of the rotatable bridging members at primary contact “making” and “breaking” times.

The rotatable bridging members are preferably adapted to rotate in tandem and may therefore be rotated by the same rotary actuator. In practice, the rotatable bridging members can be mounted to a common drive shaft so that the respective contact systems of each pole are synchronised in phase with respect to the common rotary actuation.

The rotatable bridging member and the fixed busbars of each pole will preferably be axially spaced apart to avoid any potential flashover between poles.

Full arcing between the rotatable bridging member and the fixed busbars of each pole is initiated when respective arcing contacts physically separate. The interaction of generated magnetic flux with the current loop flowing through each pole creates a radial repulsive force which deflects each arc away from the centre of the current loop. This increases the arc length and increases the arc voltage in the process. It also causes the rotatable bridging member of each pole to be accelerated away from the associated busbars towards the open position. This increases the separation between the respective arcing contacts which further increases the arc length.

The current loops flowing through the two poles are in opposite directions. This can be achieved by appropriate connection of the fixed busbars to the external circuit. The current loops are mutually coupled and if the current flows in opposite directions then resulting magnetic flux will interact with the current loops in a manner that generates a repulsive force between the current loops. This causes arcs in the contact systems of the two poles to be repelled from each other, hence reducing the risk of flashover between poles.

The whole of the rotary switch is preferably immersed in a liquid dielectric. It will be readily appreciated that the term “liquid dielectric” is not just intended to cover proprietary liquids that are specifically marketed as such, but any liquid that has a sufficient dielectric withstand. This would include de-ionised water, FLUORINERT and other equivalent perfluorocarbon fluids, mineral transformer oils, silicone transformer oils, synthetic oils and esters, methylene chloride etc. A particularly preferred coolant fluid is a proprietary transformer insulating fluid such as MIDEL and its equivalents. The liquid dielectric improves the cooling of the rotary switch and the generation of arc voltages as described in more detail below. The liquid dielectric may be stationary or, in some arrangements, may flow past the rotary switch.

In a preferred construction then the rotatable bridging members have opposite ends, each end including an arcing contact. Each of the fixed busbars has at least one primary contact and a contact arm that includes an arcing contact. The rotatable bridging members are then rotatable between a closed position where the opposite ends of each rotatable bridging member are in direct physical contact with the contact arm and the primary contact of the associated busbars, and an open position where the opposite ends of the rotatable bridging members are spaced apart from the contact arm and the primary contact of the associated busbars. Between the open and closed positions the rotatable bridging members will adopt an intermediate position where the arcing contacts on the opposite ends of the rotatable bridging member are in direct physical contact with the arcing contact on the contact arm of the associated busbars but where there is no longer any direct physical contact with the primary contacts.

The contact arm of each fixed busbar is preferably formed as an integral part of the busbar and can be suitably shaped and sized to allow the associated rotatable bridging member to move past it, in sliding contact with it, as it rotates between the closed position and the open position.

The primary contacts of the fixed busbars of each pole preferably include at least one resilient contact member that is in sliding contact with a respective end of the associated rotatable bridging member when the rotatable bridging member is in the closed position. The primary contacts represent the main flow path for current between the fixed busbars of each pole and opposite ends of the associated rotatable bridging member when the rotatable bridging member is in the closed position.

The fixed busbars of each pole may include a plurality of primary contacts. It is therefore important to note that when the associated rotatable bridging member is in the intermediate position then it is preferably spaced apart from all of the primary contacts of the busbars such that the only flow path for current between the busbars and the opposite ends of the rotatable bridging member is between the respective arcing contacts that are still in direct physical contact with each other. When a plurality of primary contacts is employed by a particular busbar then they will preferably form a group of parallel connected electrical circuits between that busbar and the respective end of the associated rotatable bridging member. As such, the continuous current rating of the rotary switch is influenced by the degree of current sharing between parallel connected electrical circuits and it is beneficial if the degree of contact wear, erosion and resultant contact resistance can be as uniform as possible. Moreover, the “making” (closing) and “breaking” (opening) current ratings of the rotary switch are influenced by any corresponding sequential “making” and “breaking” behaviour. To this end, the rotatable bridging member of each pole is preferably shaped so as to allow approximately synchronised “making” and “breaking” of all the parallel connected circuits. The speed of rotation of the rotatable bridging member of each pole is also made to be as fast as is technically practical so as to minimise the elapsed time associated with any non-synchronisation. It will be noted that the respective arcing contacts also operate as an electrical circuit that is in parallel with the primary contacts at their respective “making” and “breaking” times. This synchronisation feature is particularly beneficial when arcing contact wear and erosion has occurred in service and arcing contact resistance has increased as a result. This is because arcing contact resistance directly influences the “making” and “breaking” currents that are experienced by the respective primary contacts.

The contact system that is formed by the rotatable bridging member and the primary contacts of each pole benefits from a sliding or “wiping” contact action and significant contact pressures may be employed within the primary contact to ensure that mating contact surfaces are cleaned during relative movement. Moreover, these mating contact surfaces are not subjected to extremes of electrical erosion when parallel connecting arcing contacts are employed. These two factors result in the rotary switch having a low contact resistance and resultant voltage drop when in the closed position.

The rotary switch is preferably a double pole (or multi pole) double break rotary switch.

### DRAWINGS

FIG. 1 is a plan view of a double pole double break rotary switch according to the present invention;

FIG. 2 is a side view of the rotary switch of FIG. 1;

FIG. 3 is an end view of the rotary switch of FIG. 1;

FIG. 4 is a schematic view of the rotary switch of FIG. 1;

FIG. 5 is a plan view of the rotary switch of FIG. 1 in a closed position;

FIG. 6 is a schematic view of the rotary switch of FIG. 5;

FIG. 7 is a plan view of the rotary switch of FIG. 1 in a partially open position;

FIG. 8 is a schematic view of the rotary switch of FIG. 7;

FIG. 9 is a plan view of the rotary switch of FIG. 1 in a closed position and showing the current loop in one pole;

FIG. 10 is a plan view of the rotary switch of FIG. 1 in an intermediate (pre-arcing) position and showing the current loop in one pole;

FIG. 11 is a plan view of the rotary switch of FIG. 1 in a partially open (arcing) position and showing the current loop in one pole;

FIG. 12 is a plan view of the rotary switch of FIG. 1 in a partially open (arcing) position and showing the current loop in both poles;

FIG. 13 is an end view of the rotating switch of FIG. 1 in a partially open (arcing) position and showing the current loop in both poles; and

FIG. 14 is a schematic view show how the rotary switch of FIG. 1 can be integrated into external electrical circuitry for unidirectional dc current flow between a voltage source and a load.

The basic construction of a double pole double break rotary switch will now be described with reference to FIGS. 1 to 3. A rotary switch having three poles can be used in a three-phase ac circuit and the present invention would include a rotary switch having such a construction.

The rotary switch of FIGS. 1 to 3 is intended to be used with an external circuit such as a dc distribution architecture and provides an off-load switch for switchgear that is extremely compact and reliable. The rotary switch may also operate as an off-load isolator while the external circuit is being de-energised. The dc distribution architecture may form part of a marine power and propulsion distribution system or a transmission system for renewable energy devices such as wind turbines or subsea turbines, for example. The rotary switch would typically be opened after the current and the prospective open circuit voltage have been reduced to acceptable levels by other means (e.g. external electronic means and/or the application of a foldback characteristic). For example, the rotary switch might be opened after the current and the prospective open circuit voltage have been reduced to <20 A and <50V, respectively. Once the rotary switch has interrupted the circuit then the prospective current and voltage can be increased by other means. Preferably, sufficient time will be allowed between opening and closing the rotary switch for arc extinction to occur.

Such a rotary switch might easily be capable of carrying 3 kA when closed and withstand 300 kV when open. The principle benefits of the rotary switch are its inherent separation of arcs through the liquid dielectric and the consequent reduction of the risk of flashover between poles during the opening, recently opened and subsequent open phases. The rotary switch also has inherently high arc voltage and rapid and complete arc extension behaviour which are a result of the electromagnetic repulsions between arcs and contact systems, further aided by the cooling effect of the liquid dielectric.

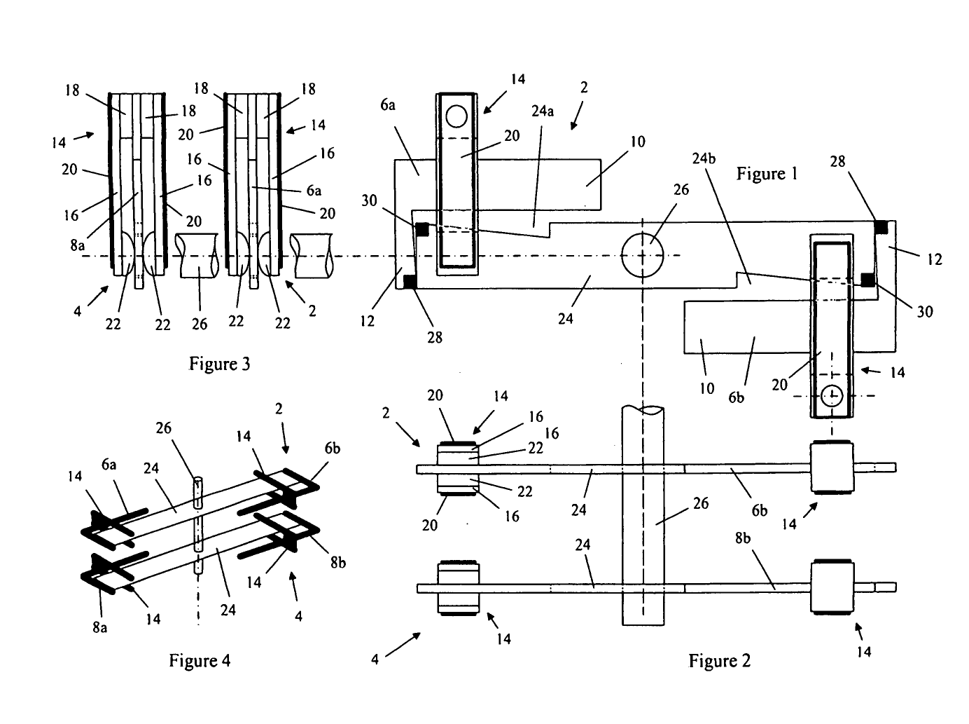

The rotary switch includes positive and negative poles 2, 4 that are axially spaced apart from each other as most clearly shown in FIGS. 2 and 3. FIG. 1 is a plan view of the positive pole 2 but it will be readily appreciated that the negative pole 4 has precisely the same construction.

Each pole 2, 4 includes first and second fixed busbars that are spaced apart in the same plane. More particularly, the positive pole 2 includes first and second fixed busbars 6a, 6b and the negative pole 4 includes first and second fixed busbars 8a, 8b. Each busbar is generally L-shaped. A first part 10 of each busbar defines the entry or exit point of a current loop and a second part 12 defines a contact arm that is shaped and sized to be in direct physical contact with an end of the rotatable bridging member (see below) when the rotary switch is in the closed position.

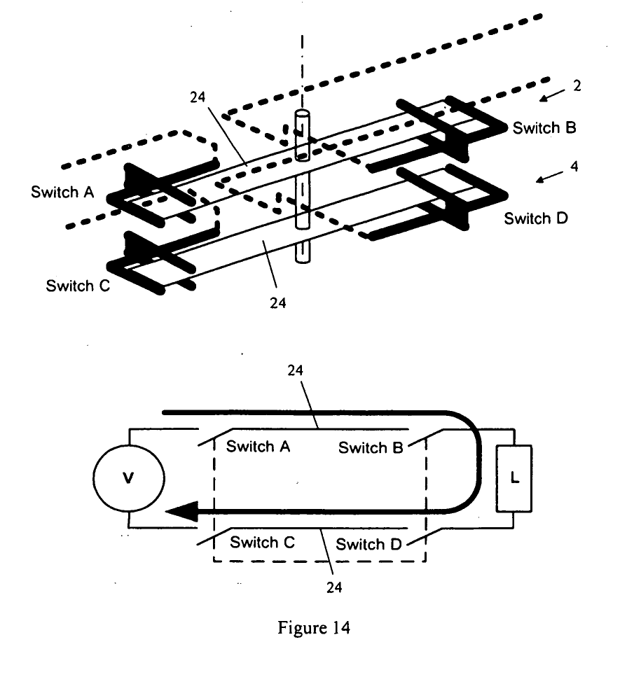

The first part 10 of each busbar can be connected to an external dc circuit (external circuitry) as shown schematically in FIG. 14 and described in more detail below. The connection with the external dc circuit can be made by any suitable means such as fixed busbars with slotted holes to allow bolted joints to be adapted to suit geometric tolerances. Alternatively, flexible links of laminated copper foil or multiple wire strand construction may be employed. External busbar connections may be made using insulated bushings or moulded busbar seals where the connections must pass through the wall of a reservoir that contains the liquid dielectric in which the rotary switch is immersed.

The second part or contact arm 12 of each busbar is angled slightly (i.e. it is thicker at its free end than where it joins with the first part 10) or otherwise profiled so that there is sufficient clearance to accommodate the opposite ends of a rotatable bridging member 24 as it moves past the contact arm with an overriding requirement that the corresponding arcing contacts 28, 30 shall be in sliding contact in the intermediate position when the contacts 14 are “making” or “breaking” contact with the rotatable bridging member 24 of the associated pole.

As most clearly shown in FIG. 3, each fixed busbar includes a contact 14 with a pair of resilient contact members (callipers) 16 that are axially spaced apart by spacers 18 and biased inwardly by leaf springs 20. The end parts 22 of the contact members 16 are designed to be in sliding contact with the rotatable bridging member 24 and can be made of copper and plated or faced with silver or a copper-tungsten alloy to provide resistance to sliding contact wear and erosion. This in turn provides a low and stable contact resistance throughout the operating lifetime of the rotary switch. Although it is generally preferred that each contact 14 includes a pair of contact members 16, it will be readily appreciated that a single contact member can also be used. Each fixed busbar may also include a plurality of co-located contacts (each having one or two resilient contact members) that can be connected together in parallel to permit a desired thermally limiting current rating for the rotary switch to be achieved.

The components that are assembled to form the contacts 14 are secured to the first part 10 of each of the fixed busbars 6a, 6b by bolted joints. Clearance holes at the fixing end of each contact 14 are shown in FIG. 1 and these may include provision for the use of an assembly jig or other assembly method that maintains the precise alignment of the contacts while they are being secured to the fixed busbars.

To improve the clarity of FIG. 3, part of the drive shaft 26 and the second fixed busbars 6b, 8b have been omitted.

Each pole 2, 4 also includes a rotatable bridging member (moving blade) 24. The rotatable bridging members 24 are mounted to a drive shaft 26 in a manner that provides electrical insulation between the rotatable bridging members and a common rotary actuator and are mechanically rotated in tandem by the common rotary actuator (not shown) such that they maintain the same physical relationship with their respective fixed busbars at all times. The rotatable bridging members 24 can be rotated between a closed position and an open position.

The rotatable bridging members 24 include a pair of notches 24a, 24b in the edges that face the first part 10 of the associated busbars when the rotatable bridging members are in the closed position. The notches 24a, 24b are designed to allow approximately synchronised “making” and “breaking” of all parallel connected circuits in the case where each fixed busbar includes a plurality of contacts 14.

The busbars and the rotatable bridging members 24 are typically made of copper. The busbars may be electroplated with a corrosion resistant metal and the rotatable bridging members may be silver plated in order to provide a low and stable contact resistance.

The general arrangement of the fixed busbars and rotatable bridging members 24 of the two pole double break rotary switch is shown schematically in FIG. 4.

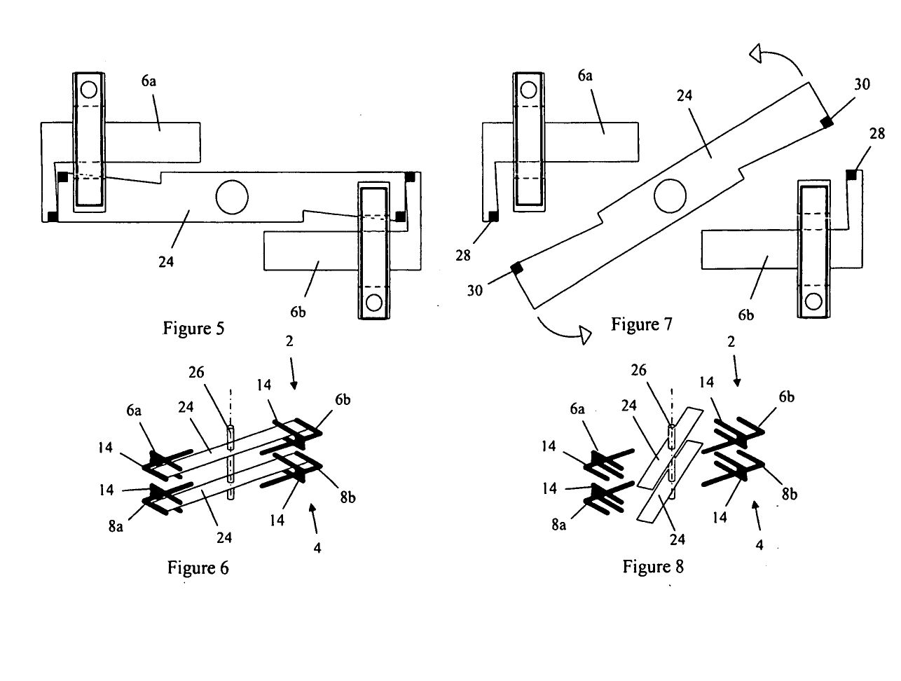

When the rotatable bridging members 24 are in the closed position the opposite ends of each rotatable bridging member are in direct physical contact with an arcing contact 28 of the respective fixed busbar and also with the resilient contact members 16 of the respective contact 14. This is shown in FIGS. 5 and 6.

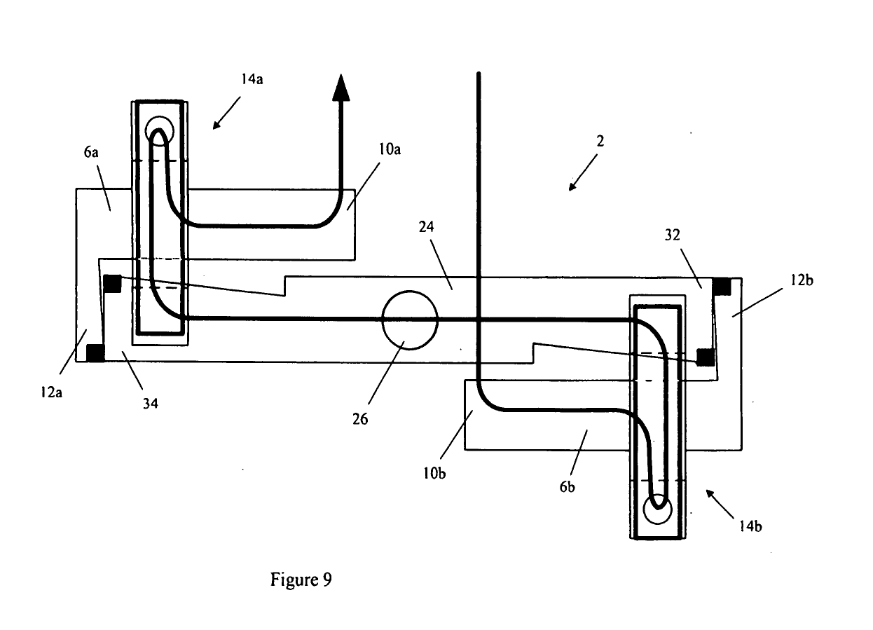

When the rotatable bridging members 24 are in the open position the opposite ends of each rotatable bridging member are no longer in direct physical contact with the arcing contact 28 of the respective fixed busbar or with the resilient contact members 16 of the respective contact 14. This is shown in FIGS. 7 and 8. When the rotary switch is fully open then the rotatable bridging members 24 will have normally undergone a rotation of substantially 90 degrees from its closed position. However, any reference herein to an “open position” does not necessarily imply a fully open position, but will include any position where there is no direct physical contact between the rotatable bridging members and the respective fixed busbars.

There is also an intermediate (or pre-arcing) position where the opposite ends of each rotatable bridging member 24 are in direct physical contact with the arcing contact 28 of the respective fixed busbar but not with the resilient contact members 16 of the respective contact 14.

The opposite ends of each rotatable bridging member 24 include arcing contacts 30 that are designed to be in direct physical contact with the arcing contacts 28 of the respective fixed busbars when the rotatable bridging members are in the intermediate position. The arcing contacts 28, 30 of the fixed busbars and rotatable bridging members are located at those extremities where arcing can be expected as the rotary switch moves from the closed position to an open position. Erosion of the arcing contacts can be minimised by the use of suitable sacrificial arcing members or arcing horns.

The rotary switch can be closed by rotating the rotatable bridging members 24 from the open position to the closed position. This can be achieved by means of the common rotary actuator (not shown) which is adapted to rotate the drive shaft 26 in a first direction to move the rotatable bridging members 24 from the closed position to the open position and in a second direction to rotate the rotatable bridging members from the open position to the closed position. As the rotary switch moves to the closed position the opposite ends 32, 34 of each rotatable bridging member 24 come into contact with the end parts 22 of the resilient contact members 16 and may push the contact members slightly apart against the inward bias of the leaf springs 20. (It will be readily appreciated that the contact members 16 may move slightly towards each other under the inward bias of the leaf springs 20 when the sliding contact with the respective end of each rotatable bridging member 24 is lost as they move from the closed position towards the open position.)

When the rotary switch is closed, the corresponding arcing contacts 28, 30 will make contact with each other before the contacts 14 make contact with the rotatable bridging members 24. Arcing may therefore occur between the arcing contacts 28, 30 in some applications that have a high inrush current, e.g. capacitive systems. During the closing of the rotary switch, the objective is for any inrush current and associated arcing to have subsided while the arcing contacts 28, 30 are in close proximity with each other.

The flow path of dc current when the rotary switch is closed will now be described in more detail with reference to FIG. 9. When the rotary switch is closed then the rotatable bridging members 24 are in a closed position and dc current can flow between the busbars 6a, 6b of the positive pole 2 as indicated by the arrow. More particularly, in the case of the positive pole 2 dc current may flow from the first part 10b of the busbar 6b that defines an entry point of the current loop and into the contact 14b. Within the contact 14b the dc current flows along the contact members 16 and into a first end 32 of the rotatable bridging member 24 through the end parts 22 of the contact members that are in sliding contact with the first end 32. The dc current flows along the rotatable bridging member 24 and into the contact 14a through the end parts 22 of the contact members 16 that are in sliding contact with the second end 34 of the rotatable bridging member. Finally, the dc current flows from the contact 14a to the first part 10a of the busbar 6a that defines an exit point of the current loop. In practice, some dc current may also flow directly between the contact arms 12a, 12b of the busbars and the rotatable bridging member 24 but this dc current will be much lower than that flowing through the respective contacts 14a, 14b as a result of the relatively high contact resistance between the fixed busbars and the rotatable bridging member. There will be a similar current loop between the busbars 8a, 8b of the negative pole 4 but the direction of current flow will be opposite as described in more detail below.

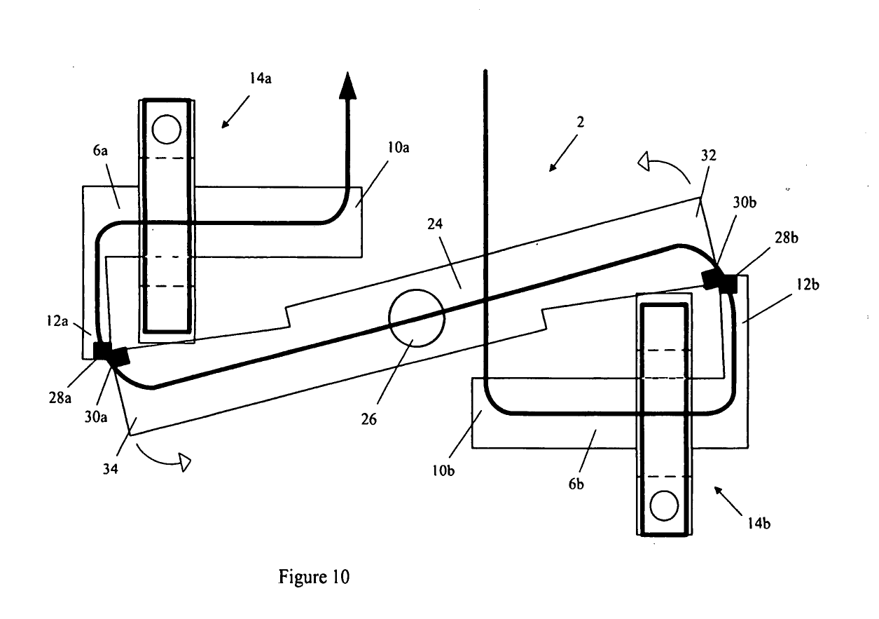

The flow path of dc current when the rotary switch is in the intermediate (or pre-arcing) position will now be described in more detail with reference to FIG. 10. When the rotary switch is in the intermediate position there is no longer any direct physical contact between the contacts 14a, 14b and the rotatable bridging member 24. However, dc current will continue to flow between the busbars 6a, 6b of the positive pole 2 as indicated by the arrow. More particularly, in the case of the positive pole 2 dc current may flow from the first part 10b of the busbar 6b that defines an entry point of the current loop, along the contact arm 12b to the fixed arcing contact 28b, then through the sliding contact resistance between the arcing contact 28b and the moving arcing contact 30b into the arcing contact 30b, and then into the first end 32 of the rotatable bridging member 24. (It will be readily appreciated that when the rotary switch is in the intermediate position then the arcing contacts 28, 30 are in direct physical contact at the opposite ends of the rotatable bridging member 24.) The dc current flows along the rotatable bridging member 24 and into the contact arm 12a through the sliding contact resistance provided by the fixed and moving arcing contacts 28a, 30a. Finally, the dc current flows along the contact arm 12a to the first part 10a of the busbar 6a that defines an exit point of the current loop. The flow of dc current between the busbars 6a, 6b is determined by the external circuitry that the rotary switch is controlling and the voltage drop between the respective pairs of arcing contacts 28a, 30a and 28b, 30b while they are still in direct physical contact with each other has minimal influence on the current in the external circuitry provided the arcing contacts are not badly warn. There will be a similar current loop between the busbars 8a, 8b of the negative pole 4 but the direction of current flow will be opposite as described in more detail below.

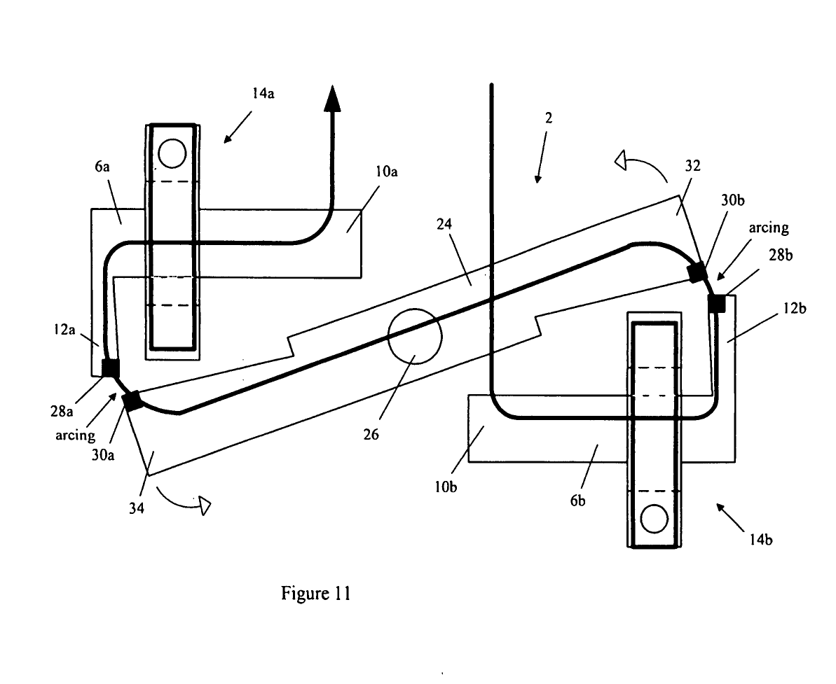

The flow path of dc current when the rotary switch is in a partially open (or arcing) position will now be described in more detail with reference to FIG. 11. When the rotary switch is in the partially open position there is no longer any direct physical contact between the contacts 14a, 14b and the rotatable bridging member 24. Neither is there any direct physical contact between the contact part 12a, 12b of each busbar 6a, 6b and the ends of the rotatable bridging member 24 (or more particularly between the respective pairs of arcing contacts 28a, 30a and 28b, 30b). However, dc current will continue to flow between the busbars 6a, 6b of the positive pole 2 as indicated by the arrow. More particularly, in the case of the positive pole 2 dc current may flow from the first part 10b of the busbar 6b that defines an entry point of the current loop, along the contact arm 12b to the arcing contact 28b. From fixed arcing contact 28b the dc current will flow, as an arc, to the moving arcing contact 30b on the first end 32 of the rotatable bridging member 24. The dc current flows along the rotatable bridging member 24 to the arcing contact 30a on the second end 34 of the rotatable bridging member 24. From arcing contact 30a the dc current will flow, as an arc, to the fixed arcing contact 28b on the contact arm 12a of the busbar 6a. Finally, the dc current flows along the contact arm 12a to the first part 10a of the busbar 6a that defines an exit point of the current loop. The flow of dc current between the busbars 6a, 6b is now only partly determined by the external circuitry that the rotary switch is controlling and is increasingly determined by the arc voltages that develop between the facing pairs of arcing contacts 28a, 30a and 28b, 30b as their arc lengths increase with the separation of the arcing contacts. There will be a similar current loop between the busbars 8a, 8b of the negative pole 4 but the direction of current flow will be opposite as described in more detail below.

The entry and exit points 10a, 10b of the current loop for the positive pole 2 are defined by the relatively closely spaced adjacent ends of busbars 6a, 6b and the corresponding busbar connections to the external circuitry. They contribute minimal magnetic flux density in the arcing regions (labelled “arcing” in FIGS. 11 to 13) between the arcing contacts 28a, 28b and 30a, 30b of the busbars 6a, 6b and the rotatable bridging member 24, respectively. This means that the magnetic flux density in each arcing region is dominated by that generated by the dc current that flows in the local current loop that includes the busbars 6a, 6b, the arcing contacts 28a, 28b and 30a, 30b, the arcing regions and the rotatable bridging member 24. The magnetic flux density interacts with the dc current in the arcs to create a radial repulsive force which, as a result of the relatively low mass within the arcs and the nature of the liquid dielectric that surrounds the arcs, deflects each arc away from the centre of the current loop. This lengthens the arc and increases the arc voltage in the process. The same electromagnetic behaviour causes the opposite ends 32, 34 of the rotatable bridging member 24 to be repelled from the fixed busbars 6a, 6b, thereby assisting the rotary actuator to move the rotatable bridging member towards the fully open position and still further increasing the arc length and arc voltage. The arc voltage will rapidly become sufficient to interrupt the current in the dc circuit. The current interruption performance of the rotary switch is therefore improved and the rotary switch can be made physically smaller and more compact. As a result, the rotary switch can have an exceptionally high power density (volts×amps/size).

The whole of the rotary switch is immersed in a liquid dielectric such as MIDEL. More particularly, the rotary switch can be located in a tank or reservoir of liquid dielectric (not shown) that may include some form of pressure relief system for accommodating the pressure wave that is generated by the opening of the rotary switch, dielectric monitoring instrumentation and other related control systems. A series of rotary switches can be located in the same tank with interposing insulation barriers to minimise the risk of flashover between adjacent rotary switches.

Immersion of the rotary switch in the liquid dielectric enhances cooling of metallic conductors and more particularly enhances the cooling of the arc, de-ionisation and arc extinction performance.

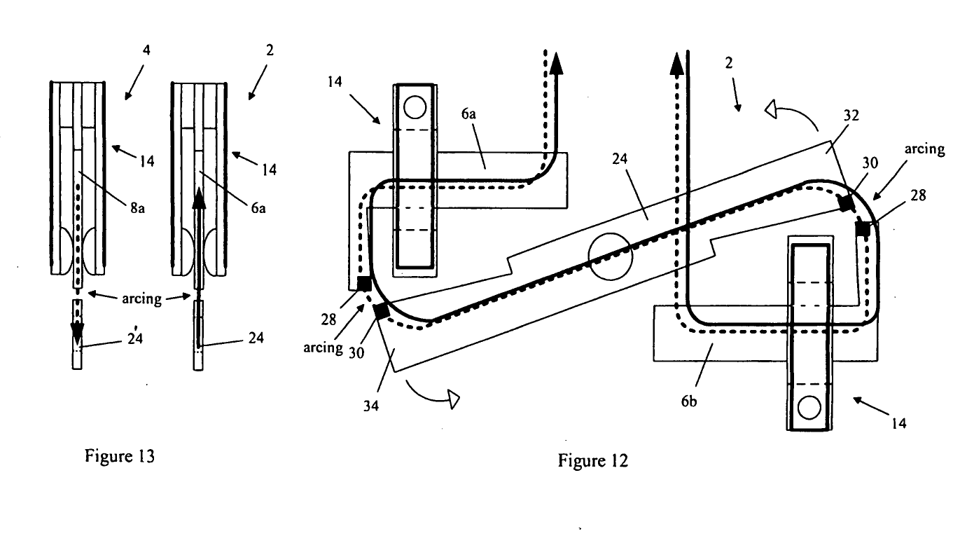

The flow path of dc current in both poles 2, 4 when the rotary switch is in a partially open (or arcing) position is explained further with reference to FIGS. 12 and 13. To improve clarity of FIG. 13 the drive shaft 26 and the second fixed busbars 6b, 8b have been omitted.

It will be seen that for the positive pole 2 the dc current flow is from the second busbar 6b to the first busbar 6a as described above and as indicated by the solid arrow. However, for the negative pole 4 the dc current flow is from the first busbar 8a to the second busbar 8b as indicated by the broken arrow. The dc currents in the two poles therefore flow in opposite directions in parallel planes. The electromagnetic interaction between the magnetic flux density and the dc current flowing in the current loops generates a repulsive force that is parallel to the rotational axis of the rotary switch and which deflects the arcs in the respective arcing regions of the positive and negative poles 2, 4 away from each other. This deflection is in opposition to the electrostatic attraction that would otherwise result in a flashover between the poles 2, 4.

There is no practical reason why for the positive pole 2 the dc current flow could not be from the first busbar 6a to the second busbar 6b and why for the negative pole 4 the dc current flow could not be from the second busbar 8b to the first busbar 8a. The direction of dc current flow in the poles 2, 4 will depend on how the busbars are connected to the external circuitry.

All current loops are mutually coupled between the poles 2, 4 and they must be separated by a sufficient distance if the axial repulsive force is to provide effective benefits. Some degree of separation is needed in any case for electrostatic reasons if flashover is to be avoided.

FIG. 14 shows a dc circuit for unidirectional current flow between a voltage source V and a load L. The two pole double break rotary switch is represented in the electrical circuit by four separate switches. It will be readily appreciated that the switches A and B correspond generally to the busbars 6a, 6b of the positive pole 2 and switches C and D correspond generally to the busbars 8a, 8b of the negative pole 4. When the rotatable bridging members 24 are rotated by the common rotary actuator (not shown) then all four switches will be opened simultaneously and interrupt the dc current flowing in each arm of the dc circuit. In practice, for a dc circuit of the type shown in FIG. 14 then the rotary switch only needs to have a single pole (i.e. switches A and B or switches C and D) such that current is only interrupted in one arm of the dc circuit, but having two poles provides better performance as a result of the summation of four arc voltages. A rotary switch of suitable construction could also be used for bidirectional current flow or ac working.

1. A rotary switch comprising first and second poles (2, 4), each pole including a rotatable bridging member (24) and a pair of fixed busbars (6a, 6b;8a, 8b) having at least one primary contact (14), wherein the rotary switch is adapted such that the direction of current flow through the first pole (2) is opposite to the direction of current flow through the second pole (4) such that arcs established in the first pole (2) are deflected away from arcs established in the second pole (4).

2. A rotary switch according to claim 1, further comprising a rotary actuator for rotating the rotatable bridging members (24) between open and closed positions.

3. A rotary switch according to claim 2, wherein the rotatable bridging members (24) are adapted to rotate in tandem.

4. A rotary switch according to claim 2 or claim 3, wherein the rotatable bridging members (24) are mounted to a common drive shaft (26).

5. A rotary switch according to any preceding claim, wherein arcs established between the rotatable bridging member (24) and the associated fixed busbars (6a, 6b) of the first pole (2) are deflected away from arcs established between the rotatable bridging member (24) and the associated fixed busbars (8a, 8b) of the second pole (4).

6. A rotary switch according to any preceding claim, wherein the rotatable bridging members (24) have opposite ends (32, 34), each end including an arcing contact (30).

7. A rotary switch according to claim 6, wherein each fixed busbar (6a, 6b; 8a, 8b) includes a contact arm (12) that includes an arcing contact (28).

8. A rotary switch according to claim 7, wherein arcs established in the first pole (2) between the arcing contacts (30) of the rotatable bridging member (24) and the arcing contacts (28a, 28b) of the contact arms (12a, 12b) of the associated fixed busbars (6a, 6b) are deflected away from arcs established in the second pole (4) between the arcing contacts of the rotatable bridging member (24) and the arcing contacts of the contact arms of the associated fixed busbars (8a, 8b).

9. A rotary switch according to any preceding claim, wherein the interaction of generated magnetic flux with the current loop flowing through each pole (2, 4) creates a radial repulsive force which deflects arcs established between the rotatable bridging member (24) and the associated fixed busbars (6a, 6b) of the first pole (2) away from the centre of the current loop flowing through the first pole (2) to accelerate the rotatable bridging member (24) away from the associated fixed busbars (6a, 6b) towards an open position.

10. A rotary switch according to claim 9, wherein the interaction of generated magnetic flux with the current loop flowing through each pole (2, 4) creates a radial repulsive force which deflects arcs established between the rotatable bridging member (24) and the associated fixed busbars (8a, 8b) of the second pole (4) away from the centre of the current loop flowing through the second pole (4) to accelerate the rotatable bridging member (24) away from the associated fixed busbars (8a, 8b) towards an open position.

11. A rotary switch according to any preceding claim, being immersed in a liquid dielectric.

12. A rotary switch according to any preceding claim, being a double pole double break rotary switch.

13. A method of using a rotary switch according to any preceding claim to interrupt the current in a circuit, the method comprising the step of:
maintaining the rotatable bridging members (24) in the closed position such that current flows between the associated fixed busbars (6a, 6b) of the first pole (2) and the associated fixed busbars (8a, 8b) of the second pole (4); and
when current is to be interrupted, opening the rotary switch by rotating the rotatable bridging members (24) towards the open position.

14. A method according to claim 13, further comprising the step of reducing the current in the circuit to an acceptable level before the rotary switch is opened.

15. A method according to claim 13 or claim 14, further comprising the step of closing the rotary switch once the current has been interrupted by rotating the rotatable bridging members (24) towards the closed position.
